(19) United States
(12) Patent Application Publication
(10) Pub. No.: US 2005/0174902 A1
(43) Pub. Date: Aug. 11, 2005

(54) Optical disc recording apparatus and method

(75) Inventor: Shinji Fujita, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/047,724

(22) Filed: Feb. 2, 2005

(30) Foreign Application Priority Data
Feb. 6, 2004 (JP) 2004-030100

(51) Int. Cl. G11B 7/085

(52) U.S. Cl. 369/47.15; 369/30.03

(57) ABSTRACT

In an optical disc having on one of the surfaces thereof a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being allocated into a user area and a spare area situated on the outer circumferential side of the user area, first volume management information in an existing file system is recorded to the inner circumferential side of the user area of the first layer, second volume management information is recorded to the outer circumferential side of the spare area of the second layer, and user data of the file system and the file management information are recorded to the user area.

### INCORPORATION BY REFERENCE

The present application claims priority from Japanese application JP2004-030100 filed on Feb. 6, 2004, the content of which is hereby incorporated by reference into this application.

### BACKGROUND OF THE INVENTION

1. Field of the Invention

This invention relates to an optical disc for recording data of a file system. More particularly, the invention relates to an optical disc recording apparatus and method for recording data to an optical disc having a single sided dual layer.

2. Description of the Related Art

An optical disc recording apparatus is an information recording apparatus having its features in non-contact, large recording capacity, high speed access, compatibility and low cost. Owing to these features, the optical disc recording apparatus has been utilized as a recording apparatus for digital audio signals and digital video signals or as an external storage apparatus for computers.

Density of the optical disc has been ever increasing in recent years with the increase of a capacity of data to be processed and a DVD having a capacity of about 4.7 GB has been put into market and has been widely utilized in comparison with a CD (Compact Disc) having a capacity of about 700 MB. A next-generation optical disc (Blu-ray Disc) having a capacity of 20 GB or more per side, capable of 2-hour recording of high definition pictures has also been put into practical application.

To achieve an easy access to data on recording media such as these optical discs, it is effective to manage the data in a file system or as a set of data, and a variety of file systems have been developed and used practically.

The DVD described above generally uses a file system called “UDF” (Universal Disc Format). The UDF makes description of a directory structure by using a file table called “file identifier” for each directory and a table called “file table” and can manage an extremely large number of files (65,537 ore more) per volume. Therefore, this is a file system particularly suitable for the recording application of a large number of files to a large capacity recording medium such as an external storage device of a computer.

The DVD employs the structure in which management information of a plurality of volumes including a volume descriptor and a starting point is held at the start and last portions of a volume space (logical space designated by a logical sector number) and improves reliability as typically shown in FIG. 2. In a rewritable DVD-RW, in particular, first volume management information to be held at the start portion of the volume space is recorded to the innermost circumferential portion of a user area of the disc and second management information to be held at the last portion of the volume space is recorded to the outermost circumferential portion of the user area of the disc as shown in FIG. 3. The recording positions of these two kinds of management information on the disc are spaced apart from each other so that even when one of the management information cannot be reproduced due to scratches, etc, on the disc surface, the other can be reproduced. In this way, the whole area of the disc is prevented from becoming non-reproducible.

To increase the capacity of discs, on the other hand, the development of next-generation optical discs having a recordable capacity of 40 GB or more is now underway by constituting an information recording layer of one side into two layers. In the dual layer disc for recording, track paths of the two layers are preferably so arranged as to oppose each other in order to cope with sequential recording while bridging the two layers as described in JP-A-9-259438 (FIG. 3, in particular). In other words, as shown in FIG. 1 or FIG. 4, this disc has a construction in which the physical sector numbers are allocated in an ascending order from an inner circumference to an outer circumference in the first layer and recording is made continuously whereas the physical sector numbers are allocated in the ascending order from the outer circumference to the inner circumference in the second layer and recording is continuously made. This construction eliminates the necessity for seek to the inner circumference after focus jump is made from the outer circumferential portion of the first layer to the outer circumferential portion of the second layer when data is sequentially recorded in such a fashion as to bridge the two recording layers. Consequently, it will be possible to shorten the positioning time and to save the capacity of the data buffer. Refer also to Hirayama et al U.S. Pat. No. 5,966,721 and No. 6,347,353 assigned to the present assignee as other related references.

### SUMMARY OF THE INVENTION

It is desired to apply the same file system of a single-layered disc such as the UDF to the dual layer disc suitable for recording described above. In the case of the combination described above, particularly in the case where the dual layer disc is a rewritable optical disc, the first volume management information is recorded to the innermost circumferential portion of the user area of the first layer and the second volume management information is recorded to the innermost circumferential portion of the user area of the second layer. Since both of the management information are recorded to the positions of the inner circumferential portions adjacent to each other in a disc radial direction, the possibility is high that both of the first volume management information and the second management information become simultaneously non-reproducible due to scratches, etc, on the disc surface. In other words, in the dual layer disc having the construction suitable for recording, data reliability drops due to disc defects such as scratches when the file system used for the single-layered discs according to the prior art is as such applied.

It is therefore an object of the invention to provide an optical disc recording apparatus and method for a single sided multilayer optical disc having high data recording capability and highly resistant to disc defects such as scratches and an optical disc having such recording capability.

According to one aspect of the invention, there is provided a single sided dual layer optical disc recording apparatus for recording data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being allocated into a user area and a spare area situated on the outer circumferential side of the user area, wherein first volume management information of user data is recorded to an inner circumferential side of the user area, second volume management information of the user data is recorded to the spare area and the user data is recorded as a file to an area of the user area other than the area of the first volume management information. In this optical disc recording apparatus, the spare area is allocated and recorded to the second layer.

According to another aspect of the invention, there is provided an optical disc recording apparatus for recording user data, first volume management information about the user data and second volume management information about the user data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being formatted into a user management area, a user data area and a spare area situated on the outer circumferential side of the user data area, by allocating logical sector numbers designated by a host to physical sector numbers of the user management area, the user data area and the spare area in accordance with a recording instruction from the host, wherein the first volume management information is allocated and recorded to the physical sector number of the user management area when the logical sector number designated by the host is equal to, or smaller than, the last logical sector number of the first volume management information and the second volume management information is allocated and recorded to the physical sector number of the spare area when the logical sector number designated by the host is equal to, or greater than, the first logical sector number of the second volume management information.

According to still another aspect of the invention, there is provided an optical disc recording method for recording data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being allocated into a user area and a spare area situated on the outer circumferential side of the user area, comprising the steps of recording first volume management information of the user data to an inner circumferential side of the user area; recording second volume management information of the user data to the spare area; and recording the user data as a file to an area of the user area other than the area of the first volume management information. In the optical disc recording method, the spare area is allocated and recorded to the second layer.

According to still another aspect of the invention, there is provided an optical disc recording method for recording user data, first volume management information about the user data and second volume management information about the user data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being allocated into a user management area, a user data area and a spare area situated on the outer circumferential side of the user data area, by allocating logical sector numbers designated by a host to physical sector numbers of the user management area, the user data area and the spare area in accordance with a recording instruction from the host, wherein the first volume management information is allocated and recorded to the physical sector number of the user management area when the logical sector number designated by the host is equal to, or smaller than, the last logical sector number of the first volume management information and the second volume management information is allocated and recorded to the physical sector number of the spare area when the logical sector number designated by the host is equal to, or greater than, the first logical sector number of the second volume management information.

According to still another aspect of the invention, there is provided an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of the recording layers being allocated into a user area and a spare area situated on the outer circumferential side of the user area, wherein first volume management information of user data is recorded to an inner circumferential side of the user area, second volume management information of the user data is recorded to the spare area and the user data is recorded as a file to an area of the user area other than the area of the first volume management information. In the optical disc, the spare area is positioned in the second information recording layer.

The construction of the invention makes it possible to improve reliability of data against defects such as scratch when the UDF, etc, ordinarily used as a file system of an optical disc is applied to a dual layer disc which is suitable for recording and in which physical sector numbers of a first layer are allocated in an ascending order from an inner circumference to an outer circumference and physical sector numbers of a second layer are allocated in the ascending order from the inner circumference to the outer circumference.

Other objects, features and advantages of the invention will become apparent from the following description of the embodiments of the invention taken in conjunction with the accompanying drawings.

### BRIEF DESCRIPTION OF THE DRAWINGS

FIG. 1 is an arrangement diagram of an area construction and volume management information of a single sided dual layer optical disc;

FIG. 2 is an explanatory view of a volume construction of a file system applied in the invention;

FIG. 3 is an arrangement diagram of an area construction and volume management information of a single sided single layer optical disc according to the prior art;

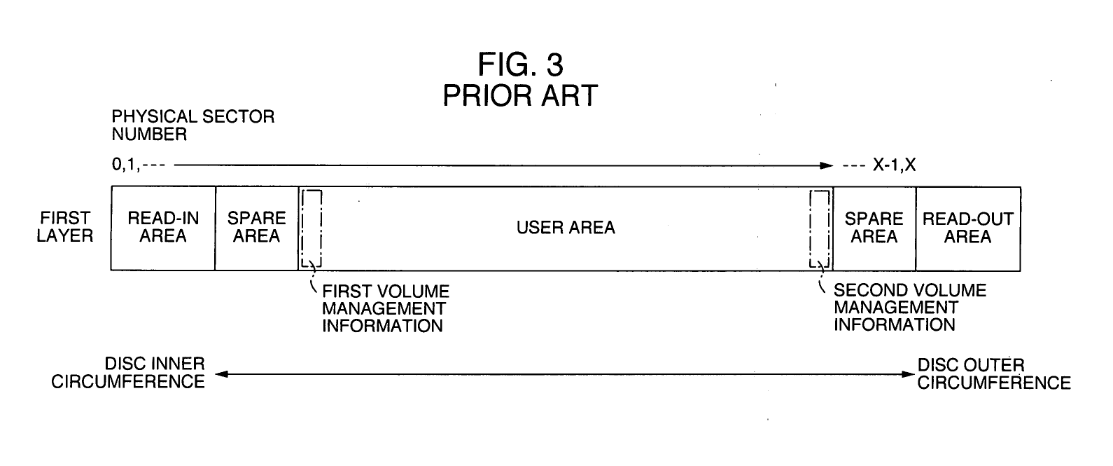

FIG. 4 is an arrangement diagram of an area construction and volume management information of a one sided dual layer optical disc according to the prior art;

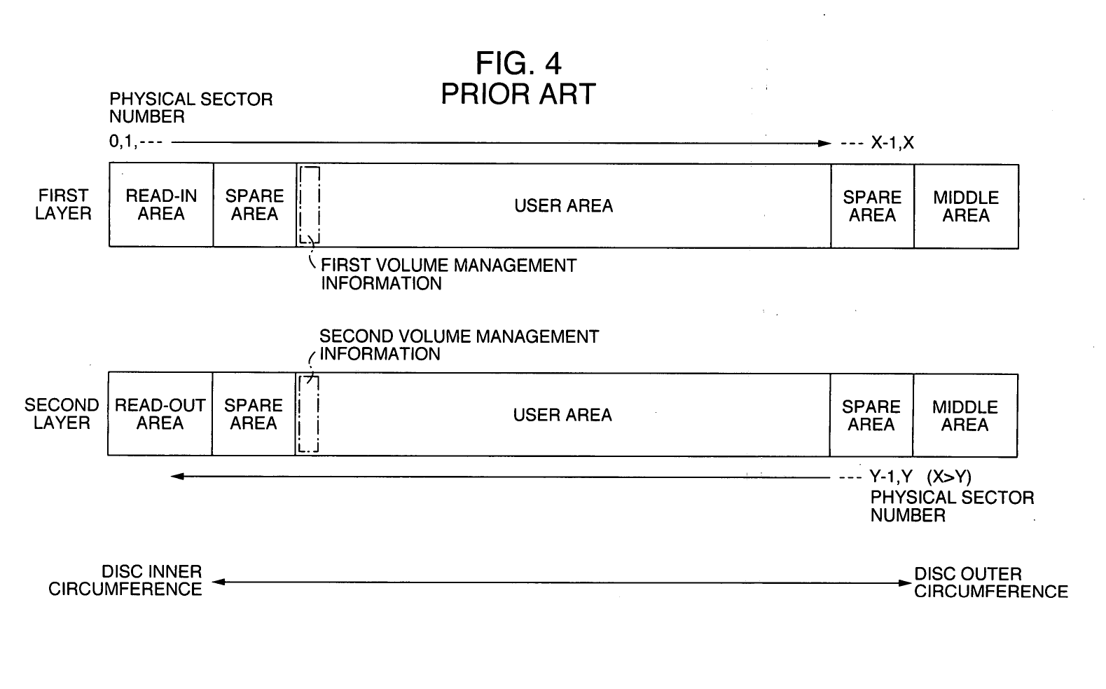

FIG. 5 is a structural view of an optical disc recording apparatus according to the invention;

FIG. 6 is a diagram showing a first correspondence relation between a logical sector number of a file system and a physical center number of an optical disc in the invention; and

FIG. 7 is a diagram showing a second correspondence relation between the logical sector number of the file system and the physical center number of the optical disc in the invention.

### DETAILED DESCRIPTION OF THE EMBODIMENTS

Embodiments of the invention will be hereinafter explained with reference to the accompanying drawings.

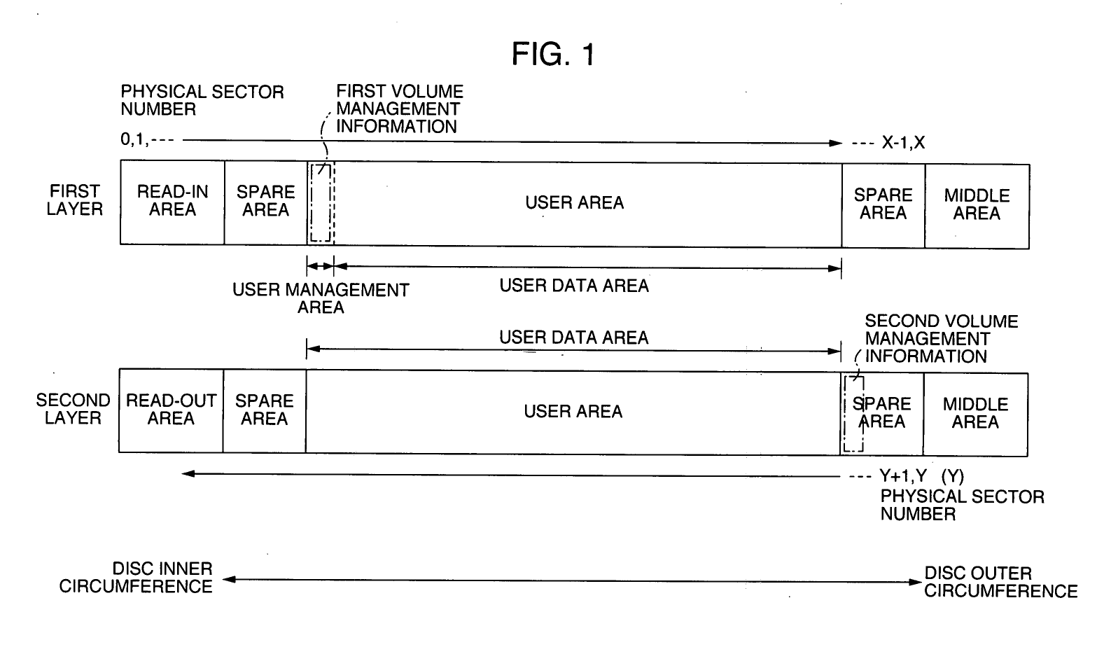

FIG. 1 is a diagram showing formats of an area construction of an optical disc and volume management information of an optical disc according to the invention. The optical disc has first and second layers as recording layers. The first layer has a spiral or concentric guide groove extending from an inner circumference to an outer circumference in a predetermined disc rotating direction (clockwise, for example) and the second layer has a spiral or concentric guide groove extending from the outer circumference to the inner circumference. In other words, track paths oppose each other in the first and second layers. Physical sector numbers are allocated in an ascending order such as 0, 1, 2, . . . , X−1 and X from the inner circumference to the outer circumference in the first layer. On the other hand, the physical sectors are allocated in the ascending order such as Y, Y+1, Y+2, . . . , Z−1, Z from the outer circumference to the inner circumference in the second layer. However, X and Y may be discontinuous provided that the relation Y>X is satisfied. Here, Y is specifically an invert (logical inversion) of X.

Each recording layer is formatted into a plurality of areas in accordance with the kind of data to be recorded and its application. The first layer is formatted into a read-in area, a first spare area, a first user area, a second spare area and a first middle from the side of the inner circumference. The first user area is further formatted into a user management area on the inner circumferential side and a first user data area on the outer circumferential side. The second layer is formatted into a second middle area, a third spare area, a second user area, a fourth spare area and a read-out area from the side of the outer circumference. The entire second user area is allocated as the user data area.

The second spare area and the third spare area have the same sector number and are substantially coincident in a disc radial direction. The start physical sector number of the second user area is an invert (logical inversion) of the last physical sector number of the first user area.

The read-in area and the read-out area are allocated to a recording area of disc information or a test write area for adjusting a recording waveform or an output. The middle area is positioned at a position corresponding to the read-out area of the single-layered disc and is used in some cases as the recording area of the disc information and the test write area in the same way as the read-out area.

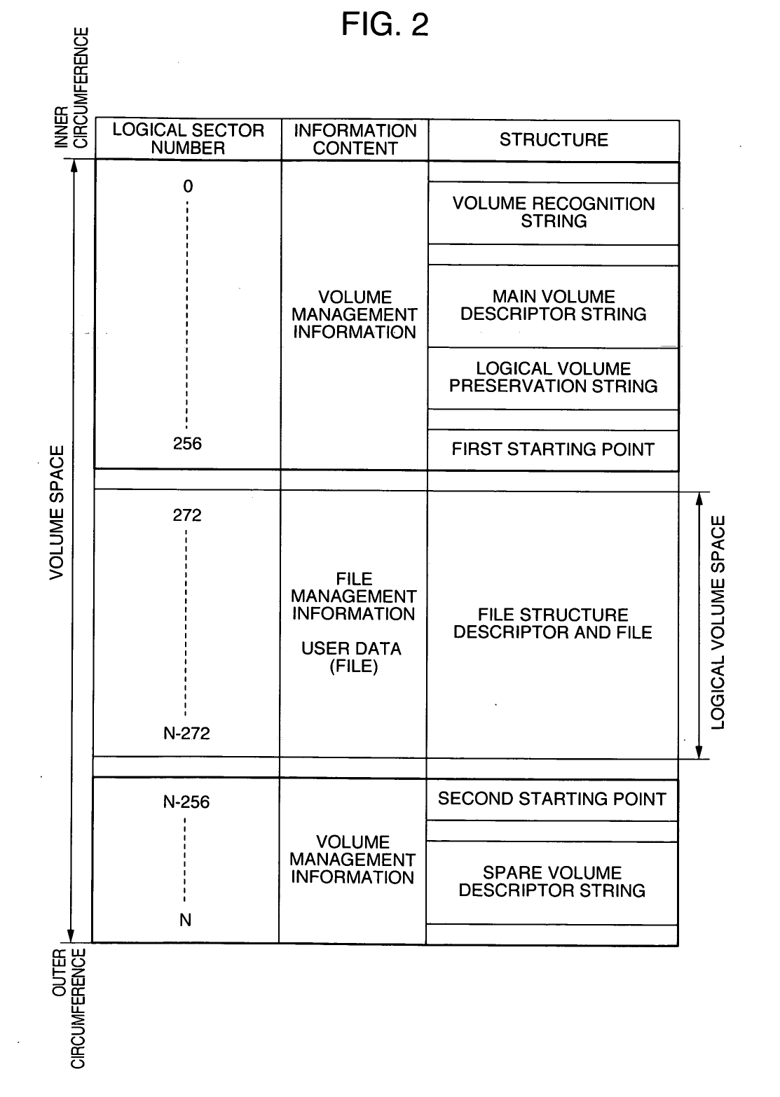

The user area is constituted by the user management area and the user data area as described already. The first volume information is recorded to the user management area. On the other hand, the user data area corresponds to the logical volume space shown in FIG. 2 and is allocated as an area to which user data of a file system and management information of this file are recorded. The last position (outermost circumferential portion) of the first user data area and the first position (outermost circumferential portion) of the second user data area are substantially coincident in the disc radial direction as described above. When recording is sequentially made in such a fashion as to bridge the first and second layers, a seek operation after focus jump from the first layer to the second layer is not necessary and the positioning time can be shortened.

The spare area is allocated as a replacement area of a disc defect. In other words, when any physical sector (defective sector) that cannot be replaced exists in the user area, the spare area is used as an area to which data to be recorded to this physical sector is recorded. Incidentally, the correspondence relation between the defective sector and the physical sector as the replacement area inside the spare area is recorded as defect management information to the read-in area. The defect management information is created at the time of initialization of the disc and can be referred to during ordinary recording and reproduction. When a new defect is found out during ordinary recording and reproduction, information about this defective sector is added to update and record the defect management information before the disc is unloaded.

A part of the third spare area is allocated as an area to which the second volume management information is recorded. Allocation of each area of the file system to on the disc is executed and recorded when the disc is initialized.

Even when the file system such as UDF is applied to the one sided dual layer optical disc suitable for recording in the construction described above, the probability that the other can make reproduction can be improved even when one of the volume management information cannot be reproduced and consequently, data reliability can be secured by arranging a plurality of volume management information at positions physically spaced apart from one another.

A part of the second spare area may be allocated as the area to which the second volume management information is recorded. However, it is preferred to use a part of the third spare area as in this embodiment by taking into account the facts that the physical characteristics of the recording layers are not always the same in the first and second layers and that optical performance of the optical pickup for making recording and reproduction to and from the optical disc is sometimes different between the first and second layers.

The optical disc according to the invention may have the construction in which the physical sector on the user area corresponding to the logical sector of the second volume management information is dealt with as the defect and the defect management information for replacing the physical sector of the second or third spare area is recorded to the read-in area.

This embodiment employs the construction in which the second volume management information is recorded to the spare area that is ordinarily used for replacement. However, this construction is not particularly restrictive and the volume management information may well be recorded to an area closer to the outer circumference than the user data area. For example, the second user management area may be disposed on the outer circumferential side of the second user data area and the volume management information may be recorded to this area. Incidentally, this second user management area can be recorded as a part of the spare area though it is not much ordinary.

In this embodiment, the start physical sector number of the second user area is the invert (logical inversion) of the last physical sector number of the first user area but this is not particularly restrictive. It is also possible to set the start physical sector number of the second user area to a value smaller than the invert of the last physical sector number of the first user area and to arrange the second user management area on the outermost circumferential portion of the second user area as described above. Since the user management area is sufficiently small, positioning to a predetermined physical sector is possible without the seek operation after focus jump. Therefore, the positioning time during the recording operation is in no way lowered.

Next, the construction of the optical disc recording apparatus according to the invention and its operation will be explained.

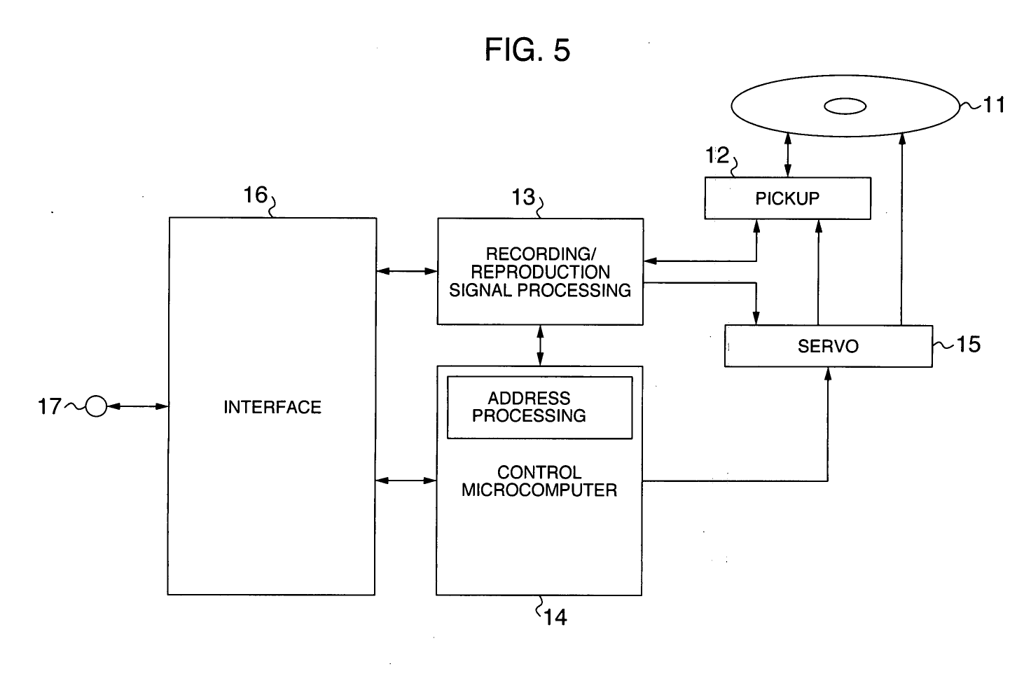

FIG. 5 is a structural view of the optical disc recording apparatus according to the invention. Referring to FIG. 5, reference numeral 11 denotes an optical disc. Reference numeral 12 denotes an optical pickup having a laser diode and a photo detector. Reference numeral 13 denotes a recording/reproduction signal processing circuit for executing an encoding processing for recording and a decoding processing for reproduction. Reference numeral 14 denotes a control microcomputer for executing operation management of each block. Reference numeral 15 denotes a servo circuit. Reference numeral 16 denotes an interface circuit with an upper apparatus. Reference numeral 17 denotes an input/output terminal.

The control microcomputer 14 receives an instruction from the upper apparatus at the time of reproduction, converts the logical sector designated by the upper apparatus to the physical sector of the optical disc 11, executes rotation control of the optical disc 11 through the servo circuit 15, feed control and focus control of the optical pickup 12 and tracking control by using each servo signal generated in the recording/reproduction signal processing circuit 13 on the basis of the output of the optical pickup 12 and gains access to the data position designated on the optical disc. The optical pickup 12 reads out the data recorded to the optical disc 11 and the recording/reproduction signal processing circuit 13 executes the decoding processing of the data so read out. The decoding processing includes a demodulation processing, an error correction processing and de-scramble processing. The physical sector read out from the optical disc 11 is converted to the logical sector by the control microcomputer 14. The main data acquired after the decoding processing is executed is outputted to the external upper apparatus (not shown in the drawing) through the interface circuit 16 and the input/output terminal 17.

When recording is made, the main data is inputted from the external upper apparatus, etc, through the input/output terminal 17 and the interface circuit 16. The recording/reproduction signal processing circuit 13 executes the encoding processing such as a scramble processing, an error correction encoding processing and a modulation processing for the main data inputted. The control microcomputer 14 converts the logical sector inputted from the external upper apparatus to the physical sector of the optical disc 11, gains access to the recording position on the optical disc 11 designated through the serve circuit 15 and writes the main data to the optical disc 11 through the optical head 12.

Here, the first method for converting the logical sector designated by the upper apparatus to the physical sector of the optical disc 11 will be explained.

The upper apparatus designates the logical sector corresponding to the main data through the interface circuit 16 at the time of reproduction or recording as described above. The logical sectors are allocated as the continuous numbers in the volume space described above and are continuous integers of 0 to N in this embodiment. The upper apparatus employs the file system such as UDF typically shown in FIG. 2. The first volume information about the entire volume is allocated to the logical sector numbers 0 as the start portion of the volume space to 256. The logical volume space including the user data of the file system and file management information is allocated to the logical sector numbers 272 to the logical sector number (N-272). The second management information is allocated to the logical sector number (N-256) as the last portion of the volume space to the logical sector number N.

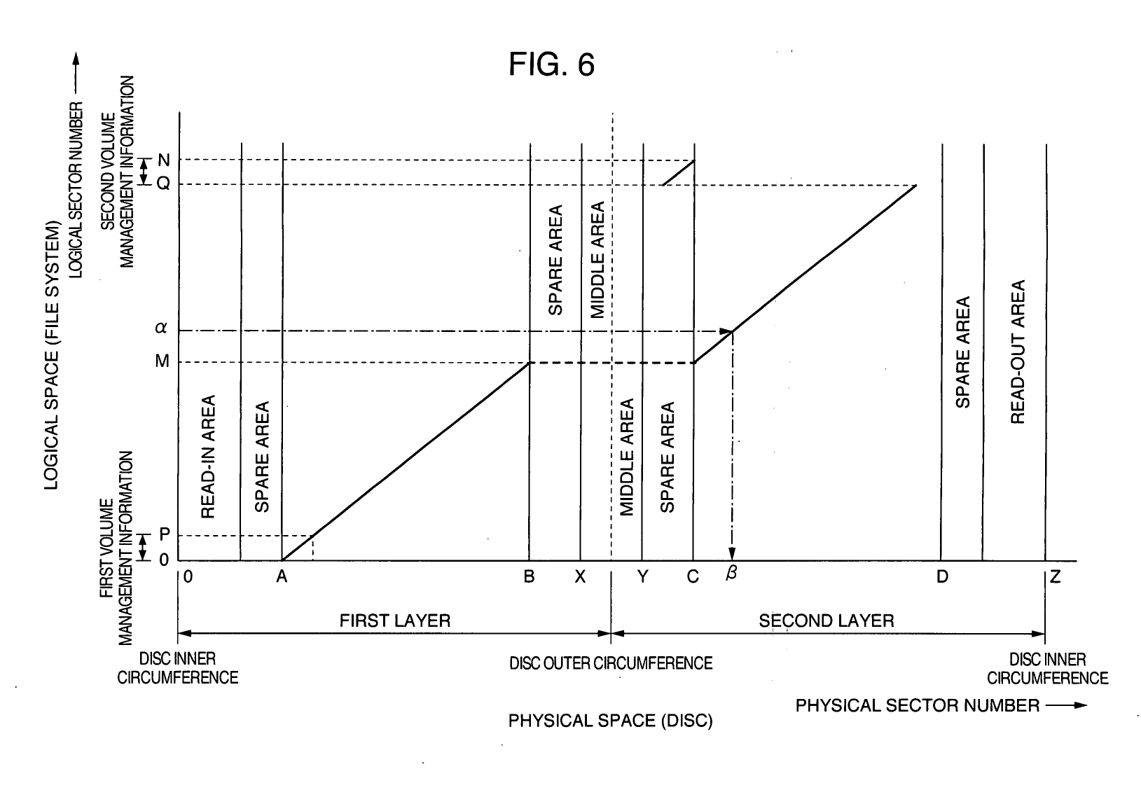

FIG. 6 shows a first correspondence relation between the logical sector number of the file system and the physical sector number of the optical disc according to the invention. Here, the first volume management information is allocated to the logical sectors 0 to P (corresponding to 256 in FIG. 2) and the second volume management information is allocated to the logical sectors Q (corresponding to N-256 in FIG. 2) to N. Further, the logical sector at the mid point of the volume space has the logical sector number M. The user area of the first layer of the optical disc 11 corresponds to the physical sectors A to B and the user area of the second layer corresponds to the physical sectors C to D. Incidentally, the number of the physical sectors of the user area is equal to, or greater than, the number of the logical sectors in the volume space. They are equal to each other in this embodiment, that is, M=B−A and N−M−1=D−C.

Assuming that the logical sector number inputted from the upper apparatus is α, address translation means inside the control microcomputer 14 outputs a physical sector number β for the input α in accordance with the corresponding relation shown in FIG. 6. In other word, when the logical sector number a satisfies the relation 0≦α≦M, the address translation means outputs a physical sector number β having a relation β=α−M+C. In the case of Q≦α≦N, the address translation means outputs a physical sector number β having a relation β=α−N+C−1.

Because the optical disc recording apparatus includes the address translation means described above, it is possible to record the first volume management information to the inner circumferential portion of the user area of the first layer of the optical disc, the logical volume space to the user area of the first or second layer and the second volume management information to the spare area of the outer circumferential portion of the second layer of the optical disc.

Management of the disc defect described above is conducted in the optical disc recording apparatus of the invention, too, though the management is not described in detail. The replacement processing is executed for the physical sector number after the address translation by referring to the defect management information read out from the disc.

The formula for converting the logical sector number α to the physical sector number β in the invention is not particularly limited to the formula described in this embodiment. For example, the second volume management information can be allocated to the spare area of the outer circumferential portion of the second layer by outputting the physical sector number β having a relation β=α−Q+Y when the logical sector number a has the relation Q≦α≦N. Alternatively, the second volume management information may be allocated to the spare area of the outer circumferential portion of the first layer by outputting a physical sector number β satisfying a relation B≦α≦X. Still alternatively, when any disc defect exists, the correspondence relation between the logical sector and the physical sector may be appropriately shifted in accordance with the defective sector length dn in the formula β=α+A+Σdn.

The above explanation represents the construction in which the second volume management information is allocated to the third spare area at the outer circumferential portion of the second layer of the optical disc. However, the optical disc of the invention is not limited to this construction as already described. The second volume management information may be allocated to the second spare area or may be recorded to a second user management area by securing it at the outermost circumferential portion of the second user area.

Next, a second method for converting the logical sector designated by the upper apparatus to the physical sector of the optical disc 11 will be explained.

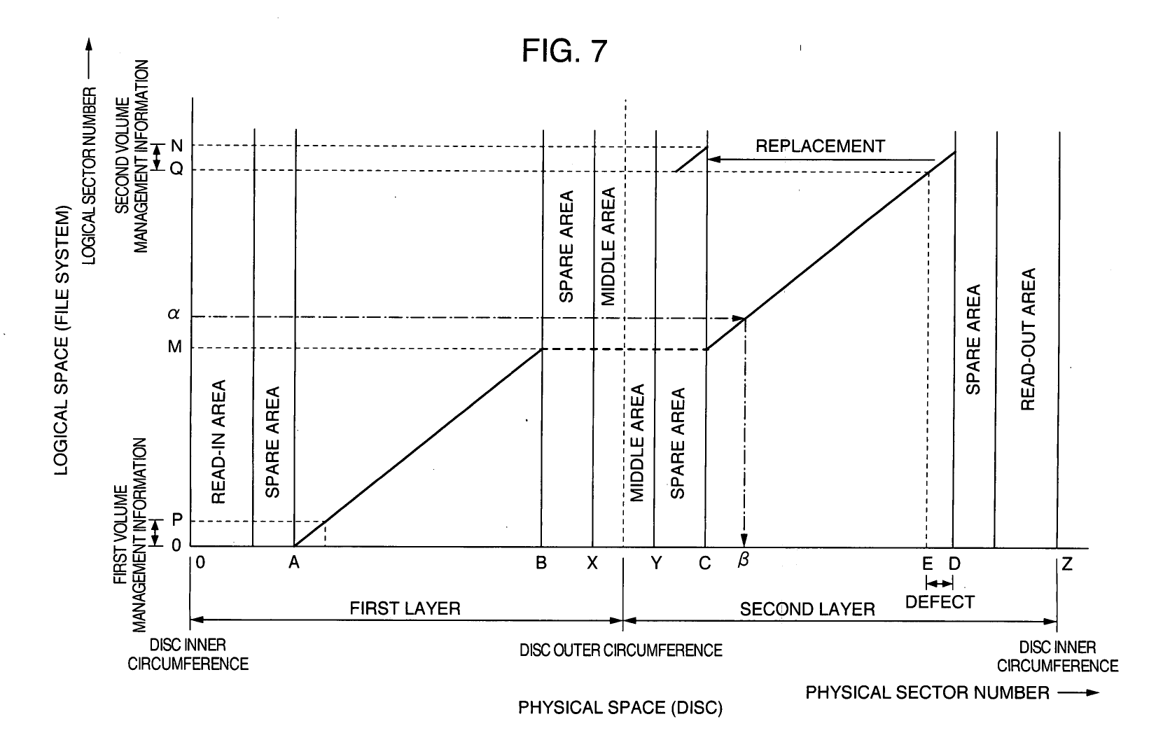

FIG. 7 shows a second correspondence relation between the logical sector number of the file system and the physical sector number of the optical disc in the invention. The physical sector number E corresponds to the start logical sector number Q of the second volume management information and satisfies a relation E=Q−M+C. The rest of symbols applied to the logical sector numbers and the physical sector numbers are the same as those of FIG. 6.

In this embodiment, the physical sectors of the physical numbers E to D are falsely regarded as the defect in an ordinary case and are recorded as defect management information to the optical disc 11 at the time of its initialization. At this time, the physical sector number of the spare area of the outer circumferential portion of the second layer is designated as the replacement area.

The address translation means inside the control microcomputer 14 outputs the physical sector number β for the logical sector number a inputted from the upper apparatus in accordance with the correspondence relation shown in FIG. 7. In other words, the address translation means outputs the physical sector number β having the relation β=α+A when the logical sector number α has the relation 0≦α≦M and outputs the physical sector number β having the relation β=α−A+C when the logical sector number a has the relation M+1≦α≦Q−1.

Next, the control microcomputer 14 refers to the defect management information read out from the disc at the time of disc unloading and executes the replacement processing. The control microcomputer 14 searches whether or not the physical sector number β is registered as the defect management information and allocates the logical sector number α to the physical sector number β′ of the replacement area registered when the physical sector number β is registered. When the replacement area exists in the same layer at this time, positioning becomes possible without focus jump and the positioning time can be shortened. Therefore, the replacement area is preferably the spare area of the outer circumferential portion of the second layer as in this embodiment.

Since the optical disc recording apparatus includes the address translation means and the replacement processing means as described above, it can allocate and record the second volume information to the spare area of the second layer. The optical disc recording apparatus can also allocate and record the first volume management information to the inner circumferential portion of the first layer of the optical disc and the logical volume space to the user area of the first or second layer. Though the embodiment has been described about the single sided dual layer disc, the invention is not limited thereto. For example, similar effects of the invention can be acquired by arranging the second volume management information area on the outer circumferential side of the user area or the spare area of the outer circumferential side in those discs in which the physical sectors are allocated in the ascending order from the inner circumference to the outer circumference in the first and third information recording layers and the physical sectors are allocated in the ascending order from the outer circumference to the inner circumference in the second and fourth recording layers.

According to the optical disc recording apparatus and the optical disc recording method of the invention described above, the single sided dual layer disc suitable for recording can take the construction of the optical disc of the invention. As a result, even when the file system such as UDF is applied, the probability that the other volume management information can make reproduction can be improved even when one of the volume management information cannot make reproduction, and reliability of data against scratches can be secured.

It should be further understood by those skilled in the art that although the foregoing description has been made on embodiments of the invention, the invention is not limited thereto and various changes and modifications may be made without departing from the spirit of the invention and the scope of the appended claims.

1. An optical disc recording apparatus for recording data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of said recording layers being formatted into at least a user area and a spare area situated on the outer circumferential side of said user area, comprising:
means for recording first volume management information of user data to an inner circumferential side of said user area;
means for recording second volume management information of said user data to an outer circumferential portion of said user area or said spare area; and
means for recording said user data as a file to an area of said user area other than the area of said first volume management information.

2. An optical disc recording/reproduction apparatus according to claim 1, wherein said spare area to which said second volume management information is recorded is allocated to said second information recording layer.

3. An optical disc recording apparatus for recording user data, first volume management information about said user data and second volume management information about said user data to an optical disc having a first information recording layer in which physical sector numbers are allocated in an ascending order from an inner circumference to an outer circumference and which includes a user management area and a second information recording layer in which physical sector numbers are allocated in the ascending order from the outer circumference to the inner circumference, each of said recording layers being formatted into at least a user data area and a spare area situated on the outer circumferential side of said user data area, by allocating logical sector numbers designated by a host to physical sector numbers of said user management area, said user data area and said spare area in accordance with a recording instruction from said host, comprising:
means for allocating and recording said first volume management information to the physical sector number of said user management area when the logical sector number designated by said host is equal to, or smaller than, a last logical sector number of said first volume management information; and
means for allocating and recording said second volume management information to the physical sector number of said spare area when the logical sector number designated by said host is equal to, or greater than, a start logical sector number of said second volume management information.

4. An optical disc recording method for recording data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of said recording layers being formatted into a user area and a spare area situated on the outer circumferential side of said user area, comprising the steps of:
recording first volume management information about said user data to an inner circumferential side of said user area;
recording second volume management information about said user data to an outer circumferential portion of said user area or said spare area; and
recording said user data as a file to an area of said user area other than the area of said first volume management information.

5. An optical disc recording method according to claim 4, wherein said spare area to which said second volume management information is recorded is allocated to said second information recording layer.

6. An optical disc recording method for recording user data, first volume management information about said user data and second volume management information about said user data to an optical disc having a first information recording layer in which physical sector numbers are allocated in an ascending order from an inner circumference to an outer circumference and a second information recording layer in which physical sector numbers are allocated in the ascending order from the outer circumference to the inner circumference, each of said recording layers being formatted into a user management area, a user data area and a spare area situated on the outer circumferential side of said user data area, by allocating logical sector numbers designated by a host to physical sector numbers of said user management area, said user data area and said spare area in accordance with a recording instruction from said host, comprising the steps of:
allocating and recording said first volume information to the physical sector number of said user management area when the logical sector number designated by said host is equal to, or smaller than, a last logical sector number of said first volume management information; and
allocating and recording said second volume management information to the physical sector number of said spare area when the logical sector number designated by said host is equal to, or greater than, a start logical sector number of said second volume management information.

7. An optical disc having a first information recording layer in which physical sector numbers are allocated in an ascending order from an inner circumference to an outer circumference and a second information recording layer in which physical sector numbers are allocated in the ascending order from the outer circumference to the inner circumference, each of said recording layers being formatted into a user area and a spare area situated on the outer circumferential side of said user area, wherein:
first volume management information about user data is recorded to an inner circumferential side of said user area;
second volume management information about said user data is recorded to an outer circumferential portion of said spare area; and
said user data is recorded as a file to an area of said user area other than the area of said first volume management information.

8. An optical disc according to claim 7, wherein said spare area to which said second volume management information is recorded is positioned in said second information recording layer.
